(19) United States
(12) Patent Application Publication
(10) Pub. No.: US 2007/0243922 A1
(43) Pub. Date: Oct. 18, 2007

(54) Scheduled competition-based auction and elimination game

(76) Inventor: Richard Cox Coupland III, Phoenix, AZ (US)

Correspondence Address: Richard Cox Coupland, III, 4557 East Calle Tuberia, Phoenix, AZ, 85018, US

(21) Appl. No.: 11/714,013

(22) Filed: Mar. 3, 2007

Related U.S. Application Data
(60) Provisional application No. 60/781,418, filed on Mar. 10, 2006.

(51) Int. Cl. G06F 19/00

(52) U.S. Cl. 463/16; 463/25

(57) ABSTRACT

A method for operating a central processor to provide a networked exchange in which one or more users can participate in a game of chance, through a hosted auction. The method comprising selection of a pre-scheduled competition that emulates a real-world event upon which to base the auction, establishing the names of entities in the auction that emulate the real-world event, selecting a payout schedule for distributions of the auction proceeds based on results of the real-world event, notifying potential bidders of the auction event, accepting bids from various bidders in an auction process that results in ownership rights to game entities awarded to winning bidders, providing notification of winning and losing bidders, determining winners and providing for payout distributions based on the payout schedule.

### CROSS-REFERENCE TO RELATED APPLICATION

This application claims the benefit of Provisional Application No. 60/781,418, filed Mar. 10, 2006 for the “COMPUTER-BASED AUCTION AND TOURNAMENT GAME PROCESS”.

### BACKGROUND OF THE INVENTION

The present invention relates generally to games, and more particularly to online electronic games of chance.

The passion and draw of sports and competition are undeniable in the human race. Literally, in every culture, in every country, there are forms of sport and competition that draw the focus, attention and passion of a significant percentage of the population. These competitive contests form a type of recreation, whether as an athlete or a spectator. Whether the Olympics, the Super Bowl, or simply a cricket match between two long-time rival clubs, competition will be watched and cheered for by millions of people.

Inextricably coupled to this fact is the passion for betting or wagering on the outcome of competition. There are countless reports and facts surrounding the unbelievable sums of money and time spent by mankind to wager, track and celebrate the outcome of these competitive matches. For example, in 2005, Las Vegas sportsbooks reported that over $90.7 million dollars was wagered on the Super Bowl, while betting for the NCAA Basketball tournament (a.k.a. March Madness) came in at $80 million dollars. These figures do not take into account the Billions of dollars that are wagered through online casinos, illegal book-makers, in office pools and between friends. Most estimates have these figures in the $4-5 billion dollar range, for the Super Bowl alone.

The data shows that there is a passion for mankind to place wagers whose outcome depends on the results of a competitive match. Further, as the data indicates, there is a far greater population of casual betters that enjoy friendly wagers on competition, whether in an office pool, amongst friends, or at the neighborhood bar. In all of these scenarios, the individuals who wish to participate in a competitive pool that involves wagers must typically meet in a single location to finalize the pool(s) and the wager positions of each player. Although there are many software applications that facilitate the creation of a tournament bracket, the prediction of what teams may win a tournament, or the fantasy style trading and auctions of teams, there does not exist an application that facilitates the direct betting on tournaments between peers.

Thus, there is an unmet need for an electronic gaming system in which players can participate in betting with other users, in an auction format, for each player/team in the competitive tournament, with rights to the team/player going to the highest bidder, and payouts following a predetermined payout schedule.

### SUMMARY OF THE INVENTION

The invention is summarized as a method for operating a central processor to provide a networked exchange in which one or more users can participate in a game of chance, through a hosted auction. This method comprises selecting a pre-scheduled competition that emulates a real-world event (RWE) upon which to base the auction. Establishing the names of entities in the auction that emulate the RWE. Selecting a payout schedule for distributions of the auction proceeds based on results of the RWE. Notifying potential bidders of the auction event, and accepting bids from various bidders in an auction process that results in ownership rights to game entities awarded to winning bidders. Providing notification of winning and losing bidders, and determining winners and providing for payout distributions based on the payout schedule.

A Real World Event (RWE) refers to any event in real life that entails one or more actors, players or teams in competition. These events are most typically, but not limited to sporting events, reality competitions, or other related competitions.

In order to accomplish method of the invention, an electronic network-based auction system is provided that comprises a server system for hosting transaction operations, and client terminals connected to the server via a communications network. Various client/server architectures may be used. The exchange host is operated by an exchange operator. Hosts and Users access the auction system to create auction events and bid on auction entities via client terminals. The server side of the system preferably comprises at least one database, an internal proxy, an external proxy, an exchange processor and a listing. The client side can be any suitable client terminal. Separate client software for hosts and auction bidders may be provided, both may be provided together, or all activity may reside on the host server.

A technical advantage of the present invention is that a system and method for networked game of chance that is based upon auction events that mirror real-world events (competitive tournaments) is provided. Another technical advantage is that the invention provides real-time exchange to occur over a network. Another technical advantage is that the Host can set the payout schedule and other parameters of the Auction to emulate any RWE for auction. Another technical advantage is that the Auction Event is interactive, allowing multiple bidders to participate by bidding on the same entity, and watching the bid increments increase and high bidder change designation during the auction process.

### BRIEF DESCRIPTION OF THE DRAWINGS

FIG. 1 is a schematic diagram representing a computer arrangement and the software modules provided herein for implementing the game of the subject invention,

FIG. 2 is a flow chart representing the auction and reporting transactions in the game,

FIG. 3 is a flowchart representing the selecting of a game template for a RWE,

FIG. 4 is a flowchart representing the creating and populating a game template that mirrors a RWE,

FIG. 5 is a flowchart representing the configuring the details for the game auction, such as start and stop,

FIG. 6 is a flowchart representing users establishing a user account,

FIG. 7 is a flowchart representing the users participating in the game auction to select and place an auction bid for a game entity that mirrors a RWE,

FIG. 8 is a flowchart representing the evaluation of bids from all users to calculate and display the payout potential for all users as each part of the RWE is completed,

FIG. 9 is a flowchart representing the game host transactions to update the results of the RWE to allow the game to calculate and display the appropriate payouts to each user,

FIG. 10 is a depiction of one potential relationship of Host game screens, and methodology for creating and managing an auction game,

FIG. 11 is a flowchart representing the internal steps to create the Host auction,

FIG. 12 is a depiction of one potential set of user game screens for auction participants,

FIG. 13 is a flowchart representing two or more users forming ad-hoc consortia to bid together for fractional rights to an entity in the subject invention,

FIG. 14 is a depiction of one potential template for a RWE, as well as potential payout distribution and user payout displays,

FIG. 15 is a depiction of another possible RWE template that allows auction of the multiple number combinations that relate to the score of a competitive RWE, and

FIG. 16 is an overall system block diagram.

### DETAILED DESCRIPTION OF THE INVENTION

Game Definitions

The following terms are used throughout this application, the definitions of which are provided to assist in understanding the various elements of the subject invention.

Game: The subject invention is provided in the form of a Game, specifically as a software Application that facilitates use by the Host, and one or more Users.

Host: The Host is the single individual who utilizes the Game to create and manage Auctions that mirror Real World Events (RWEs), such as sports tournaments. The Host will establish the game, manage the information in the Database, and generally oversee the success of the Game.

User: The Users are one or more individuals who are invited to play the Game by the Host. These individuals are potential bidders, access the Game over their personal computing devices, and participate in the game as described in the subject invention.

Application: The Game is reduced to practice in a software Application that will run on the Host computer system.

Real World Event (RWE): Refers to any event in real life that entails one or more players or teams in competition. Most typically, but not limited to sporting events, reality competitions, or other related competitions.

Entity: Refers to each player or team that is created in the Game, which mirror the players or teams in a RWE. Each Entity in the Game is available for Users to Bid during the Auction, to claim the Rights to that Entity throughout the Game.

Bid: The value that a User is willing to wager during the Auction to gain the rights to an Entity.

Auction: During a Game, all entities created by the Host that mirror a RWE are available for bidding during a determined duration. During this duration, the Entities are auctioned to the highest bidding User using the Application that facilitates the Game.

Right: The right to receive a payout for the Entity, should that Entity advance in the Game, which mirrors the results of the RWE.

Team: Any team that is participating in a RWE, consisting of more than one Player or Actor, such as the teams in a football match, or the teams in a basketball tournament.

Player: Any individual, or Actor, who is participating in a RWE, such as the individual golfers in a golf tournament, or the individual drivers in a race car event.

General Definitions

The invention will now be described with references to the like drawings, which include reference numbers to describe details throughout. It may be evident, however, that the invention can be practiced without these specific details.

While certain ways of displaying information for users are described in certain figures, those skilled in the relevant art will recognize that various other alternatives can be employed. Therefore, the terms “screen”, “web page”, and “page” are generally interchangeable herein.

While, for the purposes of simplicity of explanation, one or more methodologies shown herein, e.g., in the form of a flowchart, are shown and described as a series of acts, it is to be understood and appreciated that the subject invention is not limited by the order of acts, as some acts may, in accordance with the invention, may occur in a different order and/or concurrently with other acts that are shown and described herein. Moreover, not all stated acts may be required to implement a methodology in accordance with the invention.

The Game Format

The invention creates a game that enables a unique format for placing wagers and participation in any type Real World Event (RWE) such as a sports tournament or reality competition. Specifically, the game can be applied to any competition event that requires two or more players or teams to compete for a final outcome. This can span a specific period of a competition, or more likely the competition itself, whether a game or match, or a tournament that incorporates many teams over several rounds of competition to yield a final winner.

In addition to the implementation of the game through an application, unregistered users can also be referred to an online website, to gain a better understanding of the application and how the game operates. Through this access to examples and feature descriptions, users are enticed to become registered users of the actual application, which allow them to host their own games.

It is also possible through this online website to gain access to pre-populated games that mirror RWEs, for purchase and ownership by registered users. These pre-populated games will allow Hosts to hold auctions without the personal labor to create the Game itself.

The application is constructed to allow multiple simultaneous games to be hosted, which also mirror the fact that multiple RWEs can take place at any given time. For example, the Host can maintain a game for a basketball tournament while also maintaining a game for a golf tournament or race car event.

The application will allow any number of users to participate in any active game. For example, the Host may have 100 Users participating in a game mirroring a RWE basketball tournament, while an additional 200 Users may be participating in a game that mirrors a RWE golf tournament.

For any game being hosted, Users find the entities that mirror the players or teams in the RWE listed in the game auction. During the duration of the game auction, Users can bid in an auction format for the rights to each entity. The User with the highest bid at the completion of the auction duration is awarded the rights to the entity for the duration of the RWE. The sum of all bids by all Users creates the total payout pot for the Game. For each game template that mirrors a RWE, the rights for each entity gain the potential to receive a distribution percentage of the total payout pot if the entity advances through the RWE. For example, in the RWE known as the NCAA Men's Basketball tournament, a User may bid and win the rights to a specific team entity that mirrors that actual team in the RWE tournament. The RWE tournament has 5 rounds of play, and thus the game also has 5 rounds of play. Should the RWE team win in the first round, the User who holds the rights to the corresponding team entity will be awarded the determined percentage of the total payout pot for the first round. Should the RWE team advance again in the second round, the User who holds the rights to the corresponding team entity will be awarded the determined percentage of the total payout pot for the second round, and so on. This continues until the RWE team is eliminated, or wins the final match and the entire RWE. The User who holds the rights to the corresponding team entity will therefore be awarded the percentage of the total payout pot that is the sum of all rounds the RWE team advances.

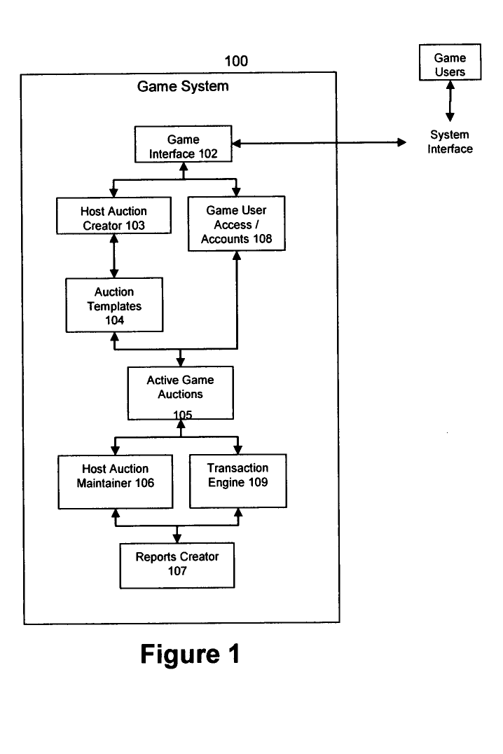

Referring now to FIG. 1, there is a schematic representation of a game system 100 (that can be implemented in hardware, software or other means) that facilitates participating in the game in accordance with the subject invention.

The game system also includes a game interface 102, that allows the Host and Users to access the game system via several different means over a network.

The Host Auction Creator 103 provides the Host the ability to create and establish specific games that mirror RWEs.

Auction Templates 104 relate to any RWE, and provide the template structure in the Host Auction Creator 103 that enable the Host to populate with player or team data that mirrors the RWE.

The Active Game Auction 105 Component contains all active or previously created auction games.

The Host Auction Maintainer 106 provides the Game Host the ability to update, maintain and oversee each created auction.

The Reports Creator 107 provides the ability to create, view or print reports that collect together relevant information pertaining to the game(s) for either the Host or the Users.

Game User Accounts Component 108 provides the ability for Users to establish their identity in the application, enabling them to participate in one or more games/auctions.

The Transaction engine 109 provides the ability for Users to place bids during an auction, and maintains the allocation of rights to each game entity based on the bids placed.

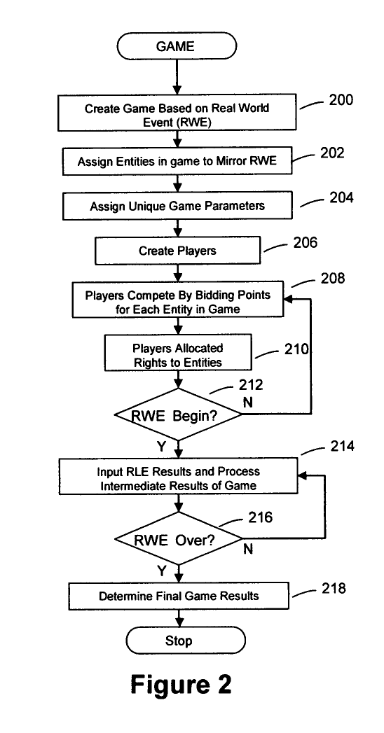

FIG. 2 is a flowchart representing the auction and reporting transactions in accordance with the invention. Upon selecting the template that represents the desired RWE, the Host populates 202 the names of each entity (players or teams) in the template. Also, the Host determines 204 the unique elements of the game, such as start and stop duration, and payout percentages.

At 206, Users are created as a result of the Host invitations, and the access of each user to the application, where they create a User Account. Once participating in the game, Users compete 208 in the auction by bidding points for a chance to gain the rights to each game entity. Users with the highest bids gain the rights to each entity at 210. This process continues in an open auction format until the end of the auction duration, which is typically the start of the RWE, at 212.

Once the RWE is underway, the Host updates the results of each RWE match in the application 214, which updates the payouts for the Users who hold rights to the entity that advances. This process continues until the completion of the RWE at 216, where the final results of the game are calculated at 218.

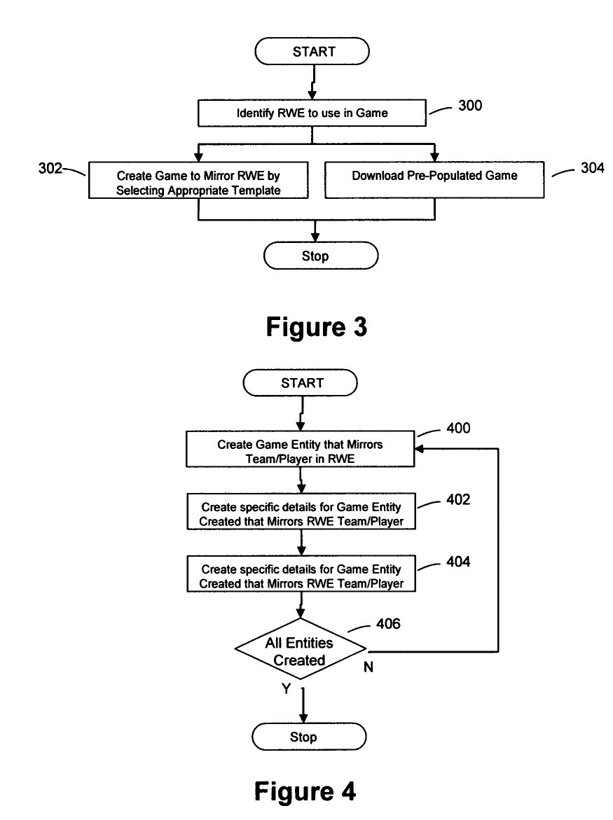

FIG. 3 illustrates a methodology for establishing what game template is selected for a RWE in accordance with the invention. Upon a decision by the Host to create a game that mirrors a RWE at 300, the Host has an option to create the game manually 302, or to obtain a pre-populated game 304 from an online website.

Should the Host elect to manually create the game, FIG. 4 is a flowchart representing the creation and population of the game template that mirrors a RWE in accordance with the invention. In the template for the game that is selected 400, the Host determines the name of each entity 402, as well as the detailed information for that entity (optional) at 404. This information will be visible to the Users throughout the auction event. The methodology for population of data into the template continues until all entities are populated 406.

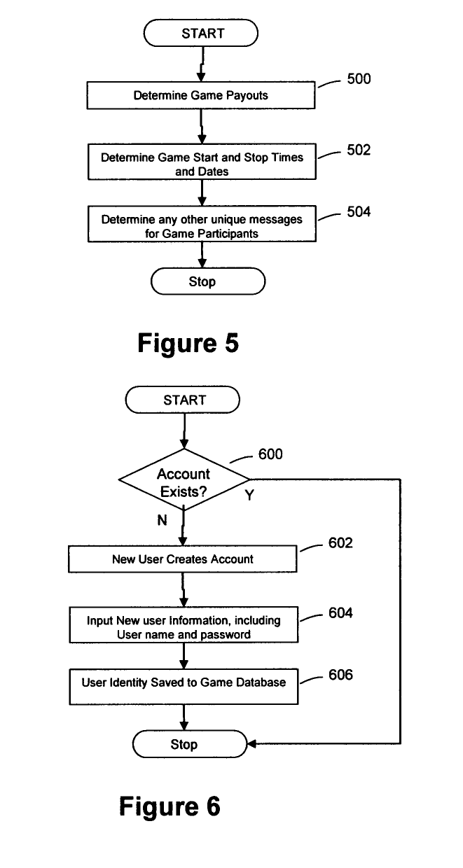

Also during the creation of a game, FIG. 5 is a flowchart representing the configuration of the details for the game auction, such as start and stop in accordance with the invention. At 500, the Host determines how the total payout pot will be distributed in each round to Users who hold rights to entities that advance. At 502, the start and stop duration for the auction event are determined, which establishes the window of time that Users can place bids on each entity. At 504, the Host can determine any additional messages or information that they would like to display to the Users during the game.

FIG. 6 is a flowchart representing the users ability to establish a user account in accordance with the invention. At 600, Users are defined by whether they have created a user Account in the Application. If not, at 602 the User is provided the ability to establish a new account. At 604, the User determines such unique data as the User Name and Password that will allow repeated access to the application in the future. Resulting User Account information is stored to the application database 606.

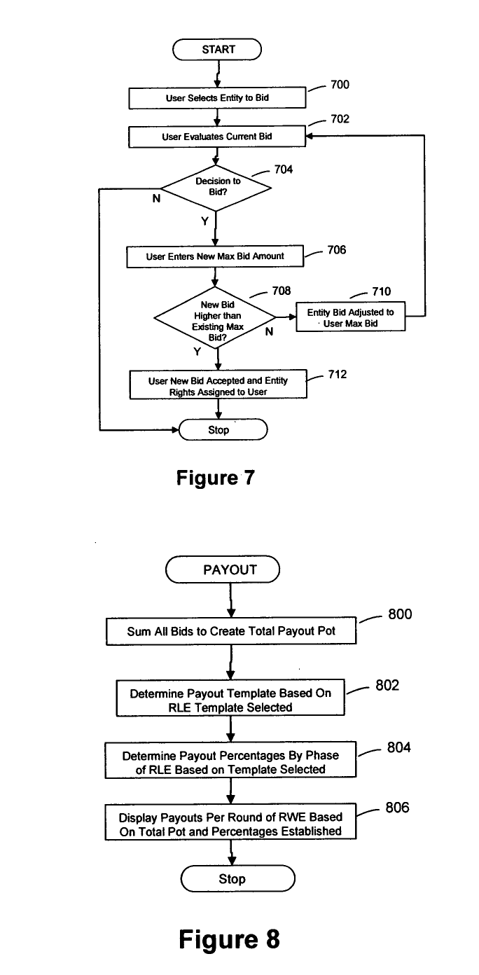

Once a User enters an active auction event, FIG. 7 is a flowchart representing the users participating in the game auction to select and place an auction bid for a game entity that mirrors a RWE in accordance with the invention. At 700, the User selects an entity that represents a player or team in the RWE that they have interest. At 702, the User evaluates the current bid amount for the entity, as well as the projected payouts for each round of the RWE that are available through the application display. Should the User make a decision to bid at 704, they establish a maximum bid amount 706 that they would be willing to bid for that entity. At 708, the application evaluates the current bid placed against the new bid amount from the User, and determines which User attains the rights to the entity through the highest bid. The results are updated in the application, and the User is informed if their bid attained the rights 712 to the entity, or if they have been outbid 710.

FIG. 8 is a flowchart representing the evaluation of the bids from all users to calculate and display the payout potential for all users as each part of the RWE is completed in accordance with the invention. At 800, the total of the bids across all game entities establishes the total payout pot. By determining the game template selected by the Host at 300, the correct payout calculation template is also determined at 802, as it is a part of the game template. Based on the template, and the payout percentages determined by the Host at 500, the application calculates the appropriate payouts 804 for each round the entity advances based on the RWE. The payout information is displayed prominently in the payout window 806 during the auction event to assist Users in determining their maximum bid threshold.

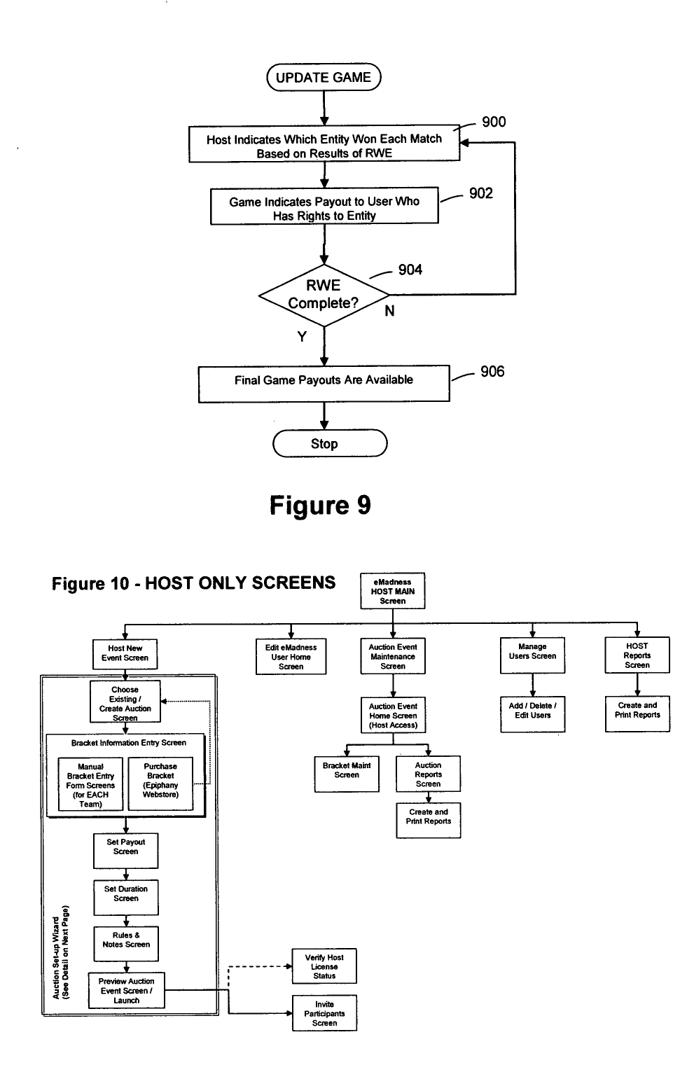

FIG. 9 is a flowchart representing the game host ability to update the results of the RWE to allow the game to calculate and display the appropriate payouts to each user in accordance with the invention. At 900, the Host updates the winning entities in the game based on the winning players or teams in the RWE. The application then calculates the User payouts 902 based on the flowchart represented in FIG. 8, and allocates them for visibility in reports or displays on screen. If the RWE is complete 904, the final payouts and reports 906 are available upon completion of this step by the Host.

FIG.10 depicts one potential relationship of Host game screens, and methodology for creating and managing an auction game, in accordance with the invention. Those skilled in the relevant art will recognize that there are many ways to create and illustrate the information in accordance with the subject invention, and this figure indicates one such arrangement.

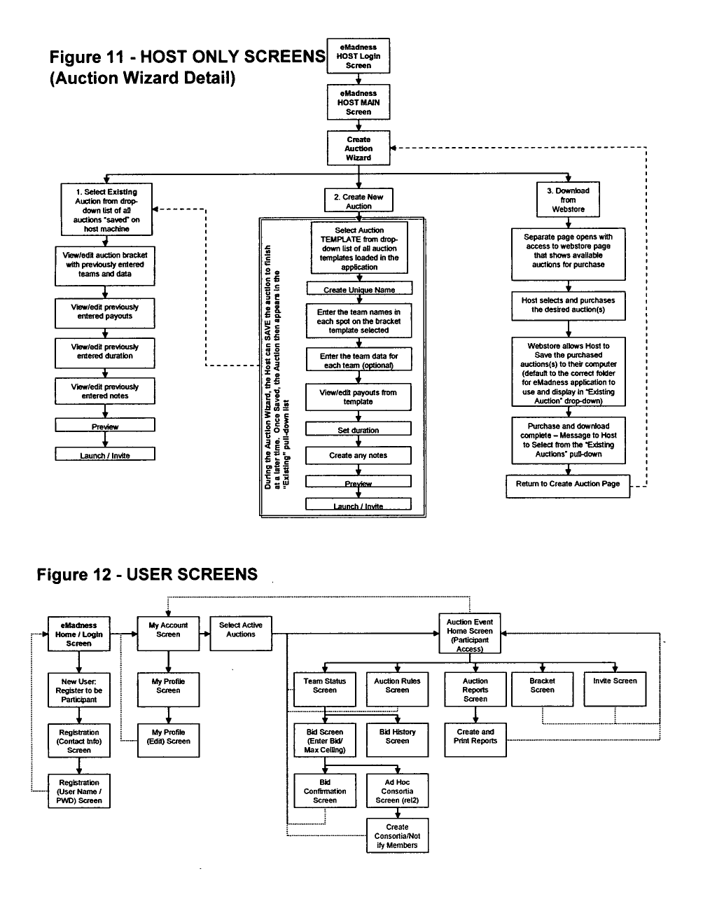

FIG. 11 is a flowchart representing the internal steps to create the Host auction, in accordance with the invention. Those skilled in the relevant art will recognize that there are many ways to create and illustrate the information in accordance with the subject invention, and this figure indicates one such arrangement. In this embodiment, the Host is presented with three options for the creation and maintenance of each game. The Host may select from a list of previously saved games, create a new game manually, or download a game from an online website.

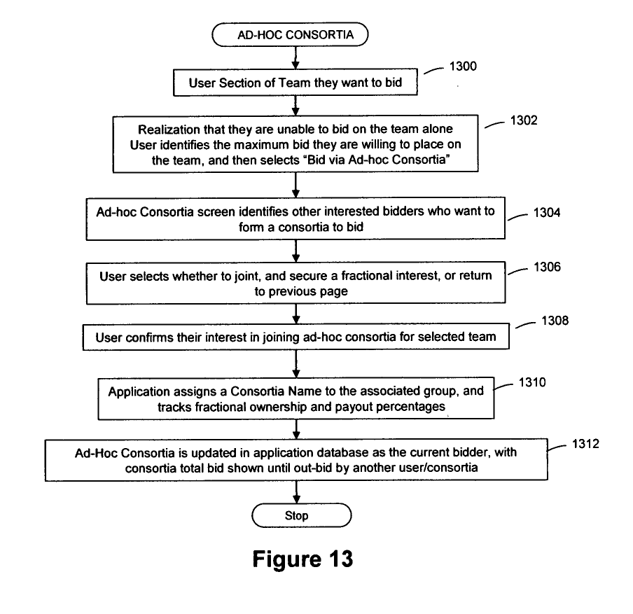

FIG. 12 depicts one potential set of user game screens for auction participants, in accordance with the invention. Those skilled in the relevant art will recognize that there are many ways to create and illustrate the information in accordance with the subject invention, and this figure indicates one such arrangement.

FIG. 13 is a flowchart representing the transactions for two or more users to form ad-hoc consortia to bid together for fractional rights to an entity in the subject invention in accordance with the invention. This feature of the invention is relevant when Users desire to bid on an entity, but the current bid exceeds their ability to individually compete for rights to the entity. At 1300, the User selects the team they wish to bid. At 1302, the User determines they are unable to compete for full rights, but are interested in competing for a fractional interest in the entity, to potentially receive a correspondingly fractional payout. By entering a maximum bid value, and indicating appropriately, the application aligns the User with other interested Users, to form Ad-Hoc consortia at 1304. The Users are given an opportunity to join the consortia, or to decline at 1306. If the User accepts at 1308, the application designates the Ad-Hoc consortia, and determines the fractional interest in the entity for each User participating at 1310. This consortium is maintained in the database at 1312. As the payout pot increases, these fractional payouts are also maintained for reports or display by the application.

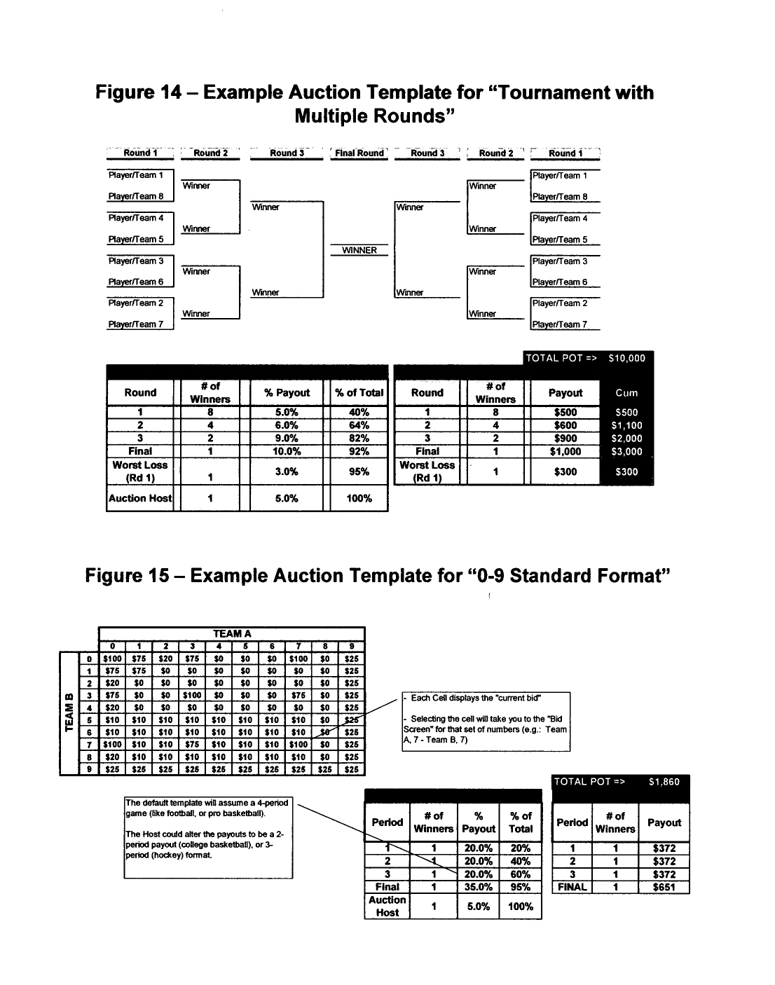

FIG. 14 depicts one potential template for a Real World Event (RWE), as well as potential payout distribution and user payout displays, in accordance with the invention. This template is for a RWE that has sixteen teams or players that compete over 4 rounds of a tournament. The payout distributions are representative, and the payout amounts assume a total payout pot of 10,000 as indicated. Those skilled in the relevant art will recognize that there are many ways to create and illustrate the information in accordance with the subject invention, and this figure indicates one such arrangement.

FIG. 15 depicts another possible RWE template that allows auction of the multiple number combinations that relate to the score of a competitive RWE, in accordance with the invention. This template is for any RWE that has two teams or players that compete with a final score as the result. In this preferred embodiment, the auction allows Users to bid on the possible number combinations that correspond to the last digits in the score of the RWE. The payout distributions are representative, and the payout amounts assume a total payout pot of 1,860 as indicated. Those skilled in the relevant art will recognize that there are many ways to create and illustrate the information in accordance with the subject invention, and this figure indicates one such arrangement.

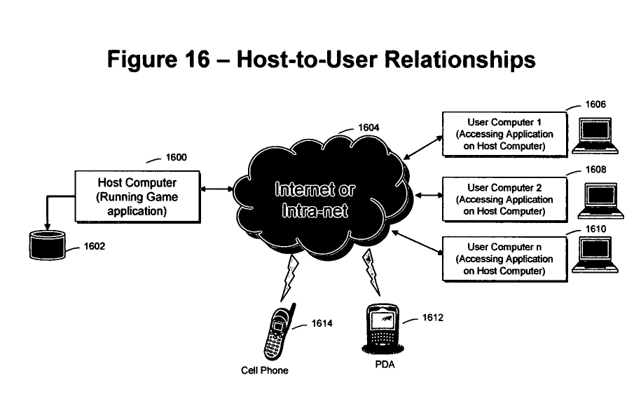

FIG. 16 is an overall system block diagram in accordance with the invention. At 1600, the Application that represents the invention resides on the Host computer. This application includes a database 1602, which contains and maintains the data in accordance with the subject invention. 1604 represents the collection of wired and wireless intra and inter networks that allow the Host computer to connect to one or more Users (1606-1610). Users may also be able to access the Game via Personal Digital Assistants 1612, or mobile telephones 1614. While the invention has been described above in the general context of computer-executable instructions that may run on one or more computers, those skilled in the art will recognize that the invention also can be implemented in combination with other program modules and/or as a combination of hardware and software. In FIG. 16, the general architecture used is a client/server architecture. Client/server architectures, per se, are generally known. As shown in FIG. 16 the Host Server operates connected to the Internet, and allows for player connectivity via client terminals. This arrangement may take the embodiment of a private party host terminal connected to multiple private party client terminals.

Another embodiment would operate as an online casino acting as the Host terminal, with multiple casino customers accessing over client terminals connected to the Casino Intra-net, or over the Internet

Another embodiment would operate as an internal network, without involvement of the Internet, such as within the controlled network of a casino, or between multiple casinos.

What is claimed is:

1. A method for operating a central processor to provide a networked exchange in which one or more users can participate in a game of chance, through a hosted auction, the method comprising:
selecting a pre-scheduled competition as a real-world event upon which to base the auction;
establishing the names of game entities in the auction representing actors in the real-world event;
selecting a payout schedule for distributions to winning bidders of the auction proceeds based on results of the real-world event;
notifying potential bidders of the opportunity to enter an auction process based on the RWE;
accepting bids from various bidders in the auction process that results in ownership rights to game entities awarded to winning bidders;
providing notification to bidders winning each entity as a result of the auction process, resulting in rights to payouts in accordance with the payout schedule;
determining winners rights that match winners in RWE, and providing for payout distributions based on the payout schedule.

2. The method of claim 1 wherein said game of chance comprises:
selecting a competitive tournament bracket that emulates a real-world event competition;
allowing players to place auction bids for entities in said tournament bracket;
collecting bids placed by auction bidders; and
distributing the total value of all bids to players whose entities progress in said real-world event such as a competitive tournament

3. The method of claim 2 wherein said step of selecting a competitive tournament bracket comprises:
specifying a unique name for said auction;
identifying the competition type (head-to-head, multi-round tournament, etc) that emulates the Real World Event (RWE) each said entity will compete;
creating of the competition template that emulates the real-world competition each said entity will compete, by specifying the name for each said entity, and the competitive matches that emulates the real-world competition each said entity will compete;
specifying the relevant descriptive information pertaining to each said entity that emulates the real-world competition;
specifying a start time for said auction;
specifying an end time for said auction;
specifying a payout distribution for all winning bidders of all proceeds gained through the auction event.
specifying instructions or notes from the host to the user(s) of the auction, for said auction; and
making said auction accessible electronically to all user(s);

4. The method of claim 1, wherein said game of chance is hosted (run) by a host.

5. The method of claim 1 wherein said step of accepting bids from various bidders comprises:
accessing the auction event via the world wide web, or other electronic network for exchange;
creating a user (bidder) account to access said auction event;
accessing said auction event using said user account information;
reviewing the various entities available for bid in the auction event, that emulate the real-world competition each said entity will compete;
placing a bid on one or more entities in the auction event;
exiting the event

6. The method of claim 1, wherein notifying potential bidders of the auction event is provided to at least one potential bidder.

7. The method of claim 6, wherein said auction electronic address is sent by E-mail or other means of notification.

8. The method of claim 1, wherein said bidder accessing said networked auction comprises:
using a graphical interface to view said auction; and
bidding on said auction entity or entities.

9. The method of claim 8, wherein said graphical interface is an electronic input/output terminal such as a personal computer or networked kiosk.

10. The method of claim 1, wherein said step of operating a central processor comprises:
receiving and storing said user account information in the central processor database;
receiving user account information from said user(s), and authenticating said user account information with said user account information for each user to allow access to said auction event;
receiving and storing said bid amounts for said entities related to bids placed by said user(s) during said auction event; and
receiving requests to display various types of information for said user(s), and displaying said requested data upon receipt of said request.

11. The method of claim 1, wherein said step of concluding said auction comprises matching the highest bid for each said entity with said user associated with said bid, for all said entities in said auction event.

12. A computer system for hosting a networked auction exchange of entities between said auction host and the said bidders (users), the system comprising:
means for establishing the names of entities in the auction that emulate the real-world event, and allocating to a database file;
means for selecting a payout schedule for distributions of the auction proceeds based on results of the real- world event;
means for notifying potential bidders of the auction event;
means for accepting bids from various bidders in an auction process that results in ownership rights to game entities awarded to winning bidders;
means for providing notification of winning and losing bidders;
means for determining winners and providing for payout distributions based on the payout schedule.

13. The computer system of claim 12, wherein said computer system comprises:
computer hardware including processor, memory, display, control devices, and interfaces to local or wide area networks and the internet;
computer software and operating system to enable the system to operate, access the network(s) and internet, as well as execute software applications installed upon it.

14. A database that assigns bidding accounts for entities in a RWE.
